(19) United States
(12) Patent Application Publication
(10) Pub. No.: US 2005/0092583 A1
(43) Pub. Date: May 5, 2005

(54) Staggering drum

(75) Inventors: Thomas Meins, Labenz (DE); Michael Nurnberg, Lauenburg/Elbe (DE); Ilmar Jonat, Hamburg (DE)

Correspondence Address: GREENBLUM & BERNSTEIN, P.L.C., 1950 ROLAND CLARKE PLACE, RESTON, VA, 20191, US

(73) Assignee: Hauni Maschinenbau AG, Hamburg (DE)

(21) Appl. No.: 10/969,039

(22) Filed: Oct. 21, 2004

(30) Foreign Application Priority Data
Oct. 30, 2003 (DE) 103 51 068.0

(51) Int. Cl. B65G 47/91

(52) U.S. Cl. 198/471.1

(57) ABSTRACT

Staggering drum for conveying rod-shaped articles of the tobacco processing industry for arranged next to one another in at least two parallel rows. The staggering drum includes conveyor disks having seats for the articles, and at least two of the conveyor disks are arranged for a row of articles. The instant abstract is neither intended to define the invention disclosed in this specification nor intended to limit the scope of the invention in any way.

### CROSS-REFERENCE TO RELATED APPLICATIONS

The present application claims priority under 35 U.S.C. §119 of German Patent Application No. 103 51 068.0, filed on Oct. 30, 2003, the disclosure of which is expressly incorporated by reference herein in its entirety.

### BACKGROUND OF THE INVENTION

1. Field of the Invention

The invention relates to a staggering drum for conveying rod-shaped articles of the tobacco processing industry, in particular filter elements, arranged next to one another in at least two parallel rows, including conveyor disks with seats for the articles. Moreover, the invention relates to a machine of the tobacco processing industry, in particular, a filter production machine or filter tipping machine.

2. Discussion of Background Information

In the present context, articles of the tobacco processing industry mean objects that are held in one or more parallel rows on conveyors, such as, e.g., on conveyor drums in filter or cigarette production machines, and are conveyed by them. Such articles are filter cigarettes and filter rods, filter segments, etc. For the sake of simplicity, if only filters or filter elements are referred to below, the reference also applies accordingly to other articles of the above-mentioned type to be conveyed.

DE-C-1 272 795 describes the removal of filter plugs, i.e., of rod-shaped articles, from a magazine by a magazine drum. Filter rods are hereby removed from the magazine and subsequently cut into filter plugs. In order to transfer the filter plugs arranged coaxially and in rows to a fluted drum in a staggered manner, an intermediate conveyor is arranged. In this manner, the intermediate conveyor has a conveyor disk for each row.

### SUMMARY OF THE INVENTION

Accordingly, the present invention provides a staggering drum with which a rapid adjustment to different lengths of filter plugs is possible.

According to the invention, a staggering drum for conveying rod-shaped articles of the tobacco processing industry, in particular filter elements, arranged next to one another in at least two parallel rows, includes conveyor disks with seats for the articles, in which at least two conveyor disks are provided for a row of articles.

The invention is based on the concept that the rod-shaped articles are received, held and staggered in the seats of several conveyor disks. This ensures a safe reception upon transfer and during transport and a reliable transfer of the staggered rod-shaped articles to other conveyor organs. Moreover, it is achieved that even longer rod-shaped articles are conveyed and staggered. In contrast to the conveyor disks known from the prior art according to DE-C-1 272 795, according to the invention several conveyor disks are provided for a row of rod-shaped articles to be conveyed. Furthermore, according to the prior art, the length of the rod-shaped filter elements is greater than the width of the seats of the individual conveyor disks.

In a preferred further development it is proposed that at least two conveyor disks are provided for each row of articles.

Moreover, it is advantageous if the spacing of two conveyor disks for a row of articles is adjustable so that the support points of the seats of the conveyor disks for rod-shaped articles of a row to be conveyed can be adjusted to the length of the article. Due to the spacing adjustment of at least two conveyor disks for a row of articles, which disks can be displaced relative to one another, the spacings are preferably selected so that the articles are reliably staggered.

A safe transfer of the articles of each row of articles is achieved if the width of the conveyor disks for a row of articles corresponds to the axial length of the articles.

Preferably, the width of the conveyor disks corresponds to the smallest axial article length that can be conveyed on the staggering drum. The width of the conveyor disks is hereby tailored to the minimum rod length to be handled on the staggering drum of the articles that are conveyed to the drum. This smallest article rod length is also taken to be the basic rod length within the scope of the invention.

According to a preferred embodiment, a combing out device is provided on the staggering drum. In contrast to the prior art, the combing out device is not arranged on the machine itself, but directly on the drum.

Preferably, the combing out device features at least one guide element and at least one combing out element for each row of articles.

In order to support a form flexibility of the staggering drum with respect to the length of the articles, the at least one guide element and/or the at least one combing out element are adjustable in their position.

To this end in particular the at least one guide element and/or the at least one combing out element can be positioned along the axis of rotation of the staggering drum.

According to the invention, a staggering drum of the type mentioned at the outset includes a combing out device provided on the staggering drum. This solution according to the invention has the advantage that the adjustment of the combing out device of the conveyor drum or staggering drum can be easily carried out on the workbench before installation in a machine, since the combing out device is easily accessible. In contrast to the prior art, the combing out device is not provided on the machine itself but directly on the drum.

Further advantageous embodiments result if the combing out device features at least one guide element and at least one combing out element for each row of articles. Preferably, the at least one guide element and/or the at least one combing out element are adjustable in their position. Moreover, according to another special further development, the at least one guide element and/or the at least one combing out element can be positioned along the axis of rotation of the staggering drum.

According to the invention, a machine of the tobacco processing industry, in particular a filter production machine or filter tipping machine, is equipped with a staggering drum according to the invention and as described above. Staggering drums are used, in particular, in filter production machines or filter tipping machines. To avoid repetitions, reference is expressly made to the staggering drum described above.

The present invention is directed to a staggering drum for conveying rod-shaped articles of the tobacco processing industry arranged next to one another in at least two parallel rows. The staggering drum includes conveyor disks having seats for the articles, and at least two of the conveyor disks are arranged for a row of articles.

In accordance with a feature of the invention, the rod-shaped articles can be filter elements.

According to another feature of the instant invention, at least two of the conveyor disks may be arranged for each row of articles.

According to still another feature of the invention, a spacing between the at least two conveyor disks is adjustable.

Further, a width of the conveyor disks for a row of articles corresponds to an axial length of the articles. The width of the conveyor disks for a row of articles corresponds to a smallest axial article length to be conveyed.

Moreover, the staggering drum can further include a combing out device. The combing out device can include at least one guide element and at least one combing out element for each row of articles. Further, at least one of the at least one guide element and the at least one combing out element can be positionably adjustable. At least one of the at least one guide element and the at least one combing out element may be positionable along an axis of rotation of the staggering drum.

The invention is directed to a staggering drum for conveying rod-shaped articles of the tobacco processing industry arranged next to one another in at least two parallel rows. The staggering drum includes conveyor disks having seats for the articles and a combing out device.

According to a feature of the invention, the combing out device can include at least one guide element and at least one combing out element for each row of articles. At least one of the at least one guide element and the at least one combing out element may be are positionably adjustable. Further, at least one of the at least one guide element and the at least one combing out element can be positionable along an axis of rotation of the staggering drum.

The invention is directed to a conveying device including the staggering drum discussed above, and a combing out device positioned on the staggering drum. The combing out device can include at least one guide element and at least one combing out element for each row of articles. At least one of the at least one guide element and the at least one combing out element may be are positionably adjustable. Further, at least one of the at least one guide element and the at least one combing out element can be positionable along an axis of rotation of the staggering drum.

The instant invention is directed to a machine of the tobacco processing industry with one of the staggering drums discussed above. The machine can be one of a filter production machine and a filter tipping machine.

Further, the invention is directed to a machine of the tobacco processing industry with the conveying device discussed above. The machine may be one of a filter production machine and a filter tipping machine.

The present invention is directed to a process of producing rod-shaped articles. The process includes arranging the articles next to one another in at least two parallel rows, and conveying the articles in seats of a plurality of conveyor disks, such that at least two of the plurality of conveyor disks are arranged for a row of articles.

According to a feature of the invention, the conveyed articles may be filter elements.

Further, the articles may be conveyed in such a manner that at least two of the conveyor disks are arranged for each row of articles.

In accordance with another feature of the instant invention, the process cab include adjusting a spacing between the at least two conveyor disks.

Further, a width of the conveyor disks for a row of articles corresponds to an axial length of the articles. The width of the conveyor disks for a row of articles corresponds to a smallest axial article length to be conveyed.

In accordance with another feature of the present invention, a staggering drum can include the plurality of conveying disks and a combing out device may be coupled on the staggering drum, and the process can further include guiding the articles into the seats via the combing out device. The combing out device can include at least one guide element and at least one combing out element for each row of articles. Further, the process can include positionably adjusting at least one of the at least one guide element and the at least one combing out element. The process may also include positioning at least one of the at least one guide element and the at least one combing out element along an axis of rotation of said staggering drum.

The instant invention is directed to a process of producing rod-shaped articles. The process includes arranging the articles next to one another in at least two parallel rows, and feeding the articles of each row to a staggering drum via a device provided on the staggering drum.

In accordance with still yet another feature of the present invention, the device provided on the staggering drum can be a combing device.

Other exemplary embodiments and advantages of the present invention may be ascertained by reviewing the present disclosure and the accompanying drawing.

### BRIEF DESCRIPTION OF THE DRAWINGS

The present invention is further described in the detailed description which follows, in reference to the noted plurality of drawings by way of non-limiting examples of exemplary embodiments of the present invention, in which like reference numerals represent similar parts throughout the several views of the drawings, and wherein:

FIG. 1 illustrates a staggering drum according to the invention; and

FIG. 2 illustrates a side view of the staggering drum depicted in FIG. 1.

### DETAILED DESCRIPTION OF THE PRESENT INVENTION

The particulars shown herein are by way of example and for purposes of illustrative discussion of the embodiments of the present invention only and are presented in the cause of providing what is believed to be the most useful and readily understood description of the principles and conceptual aspects of the present invention. In this regard, no attempt is made to show structural details of the present invention in more detail than is necessary for the fundamental understanding of the present invention, the description taken with the drawings making apparent to those skilled in the art how the several forms of the present invention may be embodied in practice.

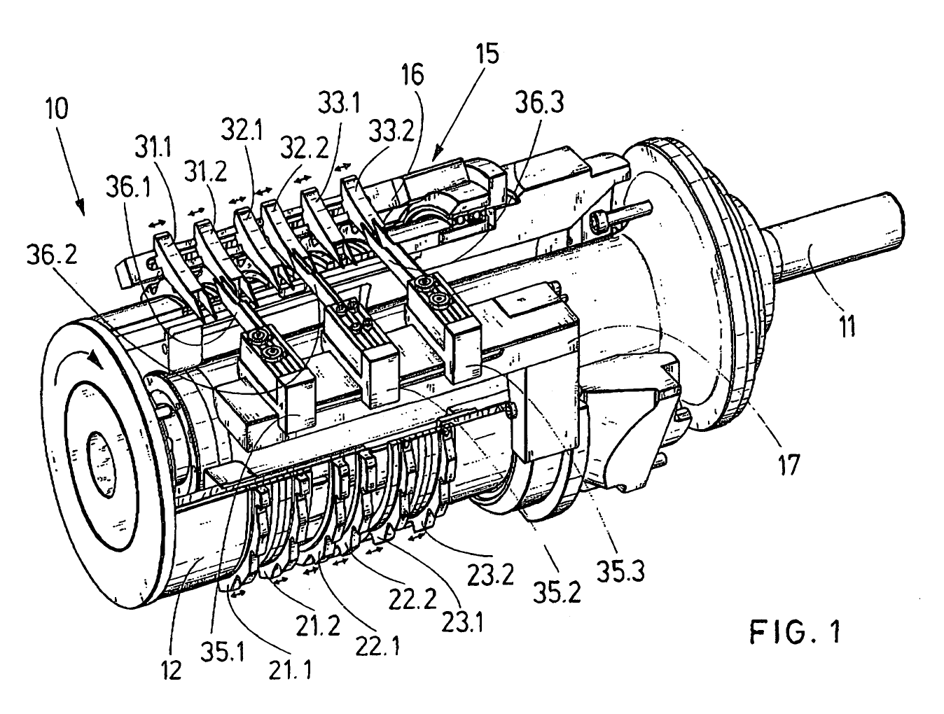

FIG. 1 shows a perspective view of a staggering drum 10. The staggering drum 10 has a rotating drum body 12 that is not shown in full for reasons of a simple representation. The drum body 12 is driven by a shaft 11 rotationally driven by a machine drive.

The drum body 12 has on its outside several conveyor disks 21.1, 21.2, 22.1, 22.2, 23.1, 23.2 that are arranged in a displaceable manner along the axis of rotation of the shaft 11. With the staggering drum 10 shown, a pair of conveyor disks 21.1 and 21.2, 22.1 and 22.2, and 23.1 and 23.2, respectively transport in their seats the rod-shaped articles of a row, e.g., of filter plugs, which are fed by another conveyor organ. In this manner, the filter plugs are fed in three rows to the staggering drum 10 and staggered by the conveyor disk pairs 21.1 and 21.2, 22.1 and 22.2, and 23.1 and 23.2. To this end, pairs of the conveyor disks 21.1 and 21.2, 22.1 and 22.2, and 23.1 and 23.2 are arranged with their seats in pairs displaced by a predetermined angle with respect to one another so that the conveyed rows of articles are transferred to another conveyor organ in a staggered manner.

Within the scope of the invention, it is possible that more than two conveyor disks are provided for a row of articles to be conveyed, such that the axial spacing between two conveyor disks for a row of articles is variably adjustable through the displaceability of the conveyor disks on the drum body 12. A high form of flexibility and adjustability to different axial lengths of the articles to be conveyed and staggered is thus achieved by the staggering drum 10 according to the invention. The width or the spacing of the conveyor disks is hereby tailored to the minimum article length to be handled.

In order to feed the individual articles of each row of articles to the staggering drum 10, e.g., from a cutting drum (not shown here), a fixed combing out device 15 is provided on the staggering drum 10. The combing out device 15 has a supporting arm 16 on which guide elements 31.1, 31.2, 32.1, 32.2, 33.1, 33.2 are arranged in a displaceable and adjustable manner. A combing out element 35.1, 35.2, 35.3 is respectively likewise arranged in a displaceable manner between two conveyor elements for a row of articles on a further supporting arm 17, that is arranged opposite the first supporting arm for the guide elements 16. Each combing out element 35.1, 35.2, 35.2 has respectively a tongue 36.1, 36.2, 36.3, that is arranged opposite and between respectively a pair of guide elements 31.1, 31.2, 32.1, 32.2, 33.1, 33.2. The combing out elements 35.1, 35.2, 35.3 have the function of guiding the articles of the respective rows of articles fed by a conveyor organ into the seats of the conveyor disk pairs 21.1 and 21.2, 22.1 and 22.2 and 23.1 and 23.2.

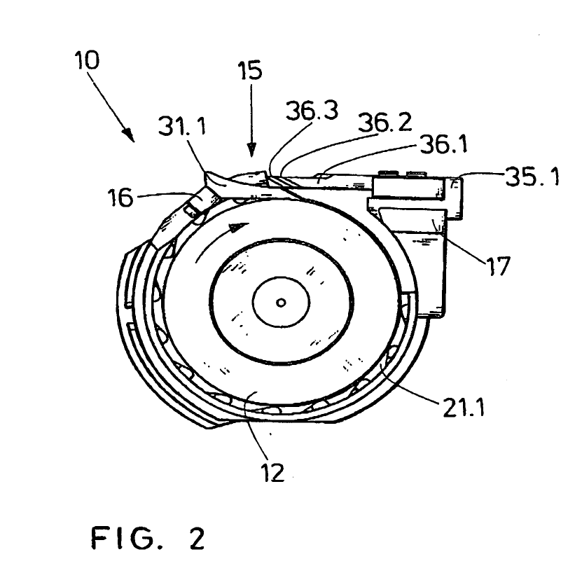

FIG. 2 shows a side view of the staggering drum 10 in which it is discernible that the guide tongues 36.1, 36.2, 36.3 of the combing out elements 35.1, 35.2, 35.3 are arranged above the sliding surfaces of the guide elements 31.1, 31.2, 32.1, 32.2, 33.1, 33.2. The tongues 36.1, 36.2, 36.3 of the combing out elements 35.1 through 35.3 extend into the guide surfaces of the guide elements 31.1, 31.2, 32.1, 32.2, 33.1, 33.2 to different extents.

It is noted that the foregoing examples have been provided merely for the purpose of explanation and are in no way to be construed as limiting of the present invention. While the present invention has been described with reference to an exemplary embodiment, it is understood that the words which have been used herein are words of description and illustration, rather than words of limitation. Changes may be made, within the purview of the appended claims, as presently stated and as amended, without departing from the scope and spirit of the present invention in its aspects. Although the present invention has been described herein with reference to particular means, materials and embodiments, the present invention is not intended to be limited to the particulars disclosed herein; rather, the present invention extends to all functionally equivalent structures, methods and uses, such as are within the scope of the appended claims.

List of Reference Numbers

10 Staggering drum

11 Shaft

12 Drum body

15 Combing out device

16 Supporting arm

17 Supporting arm

21.1, 21.2 Conveyor disks

22.1, 22.2 Conveyor disks

23.1, 23.2 Conveyor disks

31.1, 31.2 Guide element

32.1, 32.2 Guide element

33.1, 33.2 Guide element

35.1, 35.2, 35.3 Combing out element

36.1, 36.2, 36.3 Tongue

1. A staggering drum for conveying rod-shaped articles of the tobacco processing industry arranged next to one another in at least two parallel rows, said staggering drum comprising:
conveyor disks having seats for the articles; and
at least two of said conveyor disks are arranged for a row of articles.

2. The staggering drum in accordance with claim 1, wherein the rod-shaped articles are filter elements.

3. The staggering drum in accordance with claim 1, wherein at least two of said conveyor disks are arranged for each row of articles.

4. The staggering drum in accordance with claim 1, wherein a spacing between said at least two conveyor disks is adjustable.

5. The staggering drum in accordance with claim 1, wherein a width of said conveyor disks for a row of articles corresponds to an axial length of the articles.

6. The staggering drum in accordance with claim 5, wherein the width of said conveyor disks for a row of articles corresponds to a smallest axial article length to be conveyed.

7. The staggering drum in accordance with claim 1, further comprising a combing out device.

8. The staggering drum in accordance with claim 7, wherein said combing out device comprises at least one guide element and at least one combing out element for each row of articles.

9. The staggering drum in accordance with claim 8, wherein at least one of said at least one guide element and said at least one combing out element are positionably adjustable.

10. The staggering drum in accordance with claim 8, wherein at least one of said at least one guide element and said at least one combing out element are positionable along an axis of rotation of said staggering drum.

11. A staggering drum for conveying rod-shaped articles of the tobacco processing industry arranged next to one another in at least two parallel rows, said staggering drum comprising:
conveyor disks having seats for the articles; and
a combing out device.

12. The staggering drum in accordance with claim 11, wherein said combing out device comprises at least one guide element and at least one combing out element for each row of articles.

13. The staggering drum in accordance with claim 12, wherein at least one of said at least one guide element and said at least one combing out element are positionably adjustable.

14. The staggering drum in accordance with claim 12, wherein at least one of said at least one guide element and said at least one combing out element are positionable along an axis of rotation of said staggering drum.

15. A conveying device comprising the staggering drum in accordance with claim 1 and a combing out device positioned on said staggering drum.

16. The conveying device in accordance with claim 15, wherein said combing out device comprises at least one guide element and at least one combing out element for each row of articles.

17. The conveying device in accordance with claim 16, wherein at least one of said at least one guide element and said at least one combing out element are positionably adjustable.

18. The conveying device in accordance with claim 16, wherein at least one of said at least one guide element and said at least one combing out element are positionable along an axis of rotation of said staggering drum.

19. A machine of the tobacco processing industry with the staggering drum in accordance with claim 1.

20. The machine in accordance with claim 19, wherein said machine comprises one of a filter production machine and a filter tipping machine.

21. A machine of the tobacco processing industry with the staggering drum in accordance with claim 11.

22. The machine in accordance with claim 21, wherein said machine comprises one of a filter production machine and a filter tipping machine.

23. A machine of the tobacco processing industry with the conveying device in accordance with claim 15.

24. The machine in accordance with claim 23, wherein said machine comprises one of a filter production machine and a filter tipping machine.

25. A process of producing rod-shaped articles, comprising:
arranging the articles next to one another in at least two parallel rows; and
conveying the articles in seats of a plurality of conveyor disks, such that at least two of the plurality of conveyor disks are arranged for a row of articles.

26. The process in accordance with claim 25, wherein the conveyed articles are filter elements.

27. The process in accordance with claim 25, wherein the articles are conveyed in such a manner that at least two of the conveyor disks are arranged for each row of articles.

28. The process in accordance with claim 25, further comprising adjusting a spacing between the at least two conveyor disks.

29. The process in accordance with claim 25, wherein a width of said conveyor disks for a row of articles corresponds to an axial length of the articles.

30. The process in accordance with claim 29, wherein the width of said conveyor disks for a row of articles corresponds to a smallest axial article length to be conveyed.

31. The process in accordance with claim 25, wherein a staggering drum comprises the plurality of conveying disks and a combing out device is coupled on the staggering drum, and said process further comprises guiding the articles into the seats via the combing out device.

32. The process in accordance with claim 31, wherein the combing out device comprises at least one guide element and at least one combing out element for each row of articles.

33. The process in accordance with claim 32, further comprising positionably adjusting at least one of said at least one guide element and said at least one combing out element.

34. The process in accordance with claim 32, further comprising positioning at least one of said at least one guide element and said at least one combing out element along an axis of rotation of said staggering drum.

35. A process of producing rod-shaped articles, comprising:
arranging the articles next to one another in at least two parallel rows; and
feeding the articles of each row to a staggering drum via a device provided on the staggering drum.

36. The process in accordance with claim 35, wherein the device provided on the staggering drum is a combing device.
